(19) United States
(12) Patent Application Publication
(10) Pub. No.: US 2014/0258936 A1
(43) Pub. Date: Sep. 11, 2014

(54) ICONS WHICH FORM A COMPOSITE IMAGE WHEN JUXTAPOSED

(71) Applicant: BRITISH TELECOMMUNICATIONS, a public limited company, (US)

(72) Inventor: Raymond L. Lee, San Francisco, CA (US)

(73) Assignee: BRITISH TELECOMMUNICATIONS, a public limited company, London (GB)

(21) Appl. No.: 13/787,886

(22) Filed: Mar. 7, 2013

(51) Int. Cl. G06F 3/0481

(52) U.S. Cl. CPC G06F 3/04817
USPC 715/835

(57) ABSTRACT

A computer, a method, a computer-readable storage medium, and a graphical user interface, the graphical user interface including icons which form a composite image when juxtaposed.

### FIELD

The subject matter below relates generally to a device, a method, a computer-readable storage medium, and a graphical user interface, the graphical user interface including icons which form a composite image when juxtaposed.

### BACKGROUND AND SUMMARY

Software developers may offer one or more applications for purchase. Traditionally, software has been distributed on physical media which has been packaged and sold either in stores or online. The current trend in software distribution, however, is for software developers to upload and sell applications through online marketplaces. For example, users of Apple notebook and desktop computers may browse, purchase, download, and install applications from Apple's Mac App Store. This method of software distribution is particularly popular for developers of mobile phone and tablet application because each operating system (e.g., Android, iOS, Symbian, Blackberry, etc.) may have its own online application store (e.g., Google Play, Apple App Store, Nokia Ovi Store, Blackberry World, etc.) where users may browse, purchase, download, and install applications.

When software includes a large number of features and/or a complex user experience, a software developer may choose to develop multiple applications rather than one complex and feature-rich application. The multiple applications may be related. As used herein, applications may be “related,” for example, if they are developed by the same software developer or group of developers, if applications cross-reference functionality (e.g., if one application includes instructions and another application causes those instructions to be executed), if the applications share data (e.g., if one application stores data in a database or location of memory and another application reads that data), if the applications are branded, marketed, or distributed as a set of applications, etc.

Developing multiple applications provides a number of benefits. While users may find one complex application too complicated to use, individual applications may each provide a streamlined and user-friendly experience which focuses on the core feature set of each individual application.

Because applications may be listed individually in an online marketplace, offering multiple applications may increase visibility of the software developer's products. If users download more than one application, the software developer may benefit from an increase in sales and revenue. Alternatively, offering multiple applications with smaller feature sets may provide the flexibility to offer the individual applications at lower prices than would be charged for a single application combining all of the features.

Once installed, individual applications may each be associated with an individual icon. Multiple icons associated with multiple applications offer greater visibility for a software developer's applications than one icon associated with one application.

Increased visibility of software applications may lead to greater usage which in turn may lead to greater sales of future software developments as well as an increase in publicity for the developer. A lack of visibility of software applications is particularly problematic on operating systems which limit whether applications may run in the background. In those instances, an application may not open unless a user selects the desired icon.

When distributed through physical media, related applications may be sold together with options for the user to choose whether to install one or more of the applications. Furthermore, the operating system of the computing device or an installation program included on the physical media may include instructions to manipulate the graphical user interface of the computing device to indicate to the user that the applications are related. For example, the icons of related applications may be placed together in a folder.

When distributed through an online marketplace, however, the online marketplace may dictate that each application is downloaded separately. When downloaded and installed on a computing device, each individual application may be represented by a single icon of the developer's choosing. The operating system of the computing device on which the individual applications are installed may not include instructions to manipulate the graphical user interface of the computing device to indicate to the user that the applications are related. For example, a computing device may place icons of newly installed applications in a generic “Applications” folder or in the first available screen location.

Accordingly, a user may download two related applications and the icons associated with the two related applications may not be arranged in such a way as to in indicate that the applications are related.

In order to benefit from all of the functions offered by the software developer's applications, the user must download multiple applications and keep multiple applications up to date. Furthermore, if an application cross-references functionality included in a related application or applications, then that application may have reduced functionality if the user has not installed all of the related applications.

Therefore, there is a need for a graphical user interface which presents related applications in such a way as to indicate to the user whether all the related application have been installed and are up to date. At the same time, there is a need for a graphical user interface which increases a user's awareness of applications.

### BRIEF DESCRIPTION OF THE DRAWINGS

FIG. 1 illustrates a typical graphical user interface.

FIG. 2 illustrates an exemplary embodiment of a computer.

FIG. 3 illustrates an exemplary embodiment of a graphical user interface.

FIG. 4 illustrates another exemplary embodiment of a graphical user interface.

FIG. 5(a) illustrates another exemplary embodiment of a graphical user interface.

FIG. 5(b) illustrates an exemplary embodiment of metadata.

FIG. 5(c) illustrates an exemplary embodiment of a control program.

FIGS. 6(a)-6(c) illustrate other exemplary embodiments of a graphical user interface.

FIG. 7 illustrates another exemplary embodiment of a graphical user interface.

FIG. 8 illustrates another exemplary embodiment of a graphical user interface.

FIG. 9 illustrates another exemplary embodiment of a graphical user interface.

FIG. 10 illustrates another exemplary embodiment of a graphical user interface.

### DETAILED DESCRIPTION OF EXEMPLARY EMBODIMENTS

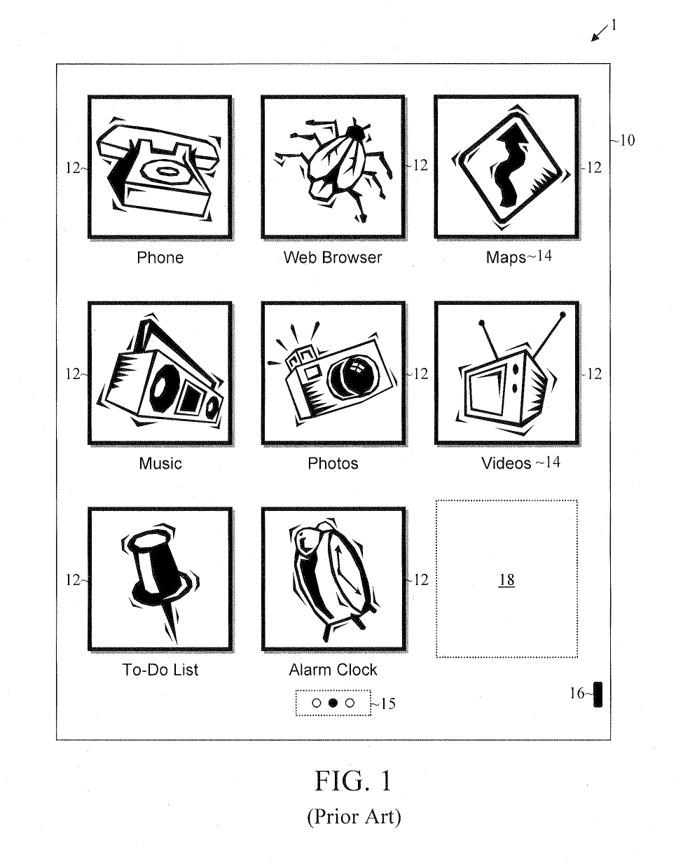

FIG. 1 illustrates a typical graphical user interface 1, including a screen 10 displaying a plurality of icons 12. Each of the plurality of icons 12 are associated with one or more functions which are performed when the icon is selected by a user. The one or more functions associated with an icon 12 may be instructions to launch an application, open a folder, etc. In certain embodiments, some or all of the icons 12 may include labels 14 identifying functions associated with the icons 12. A user may select one of the plurality of icons through an input device, (e.g., by touching a touch-sensitive display screen).

The icons 12 may be presented on a screen 10. If the graphical user interface includes more icons 12 than will fit on screen 10, the graphical user interface 1 as defined by an operating system may include a method to translate the images on the screen 10 to display additional icons 12. For example, the typical graphical user interface 1 may include multiple pages and a page indicator 15 to inform the user of the currently displayed page. Alternatively, graphical user interface 1 may scroll continuously to display additional icons 12 and include a scroll indicator 16 to inform the user of the currently displayed location.

If a new application is installed, the operating system via its graphical user interface 1 may dictate where icon 12 associated with the newly installed application is placed. For example, graphical user interface 1 may place new icon 12 in the first available location identified by box 18 of FIG. 1. Once an icon 12 is added to location 18, the next icon 12 which is added to graphical user interface 1 may be located on a subsequent line or subsequent page not currently shown on screen 10. As the above example demonstrates, if two related applications are installed, a typical graphical user interface 1 may not present the icons 12 associated with the related applications in such a manner so as to indicate to the user that the applications are related.

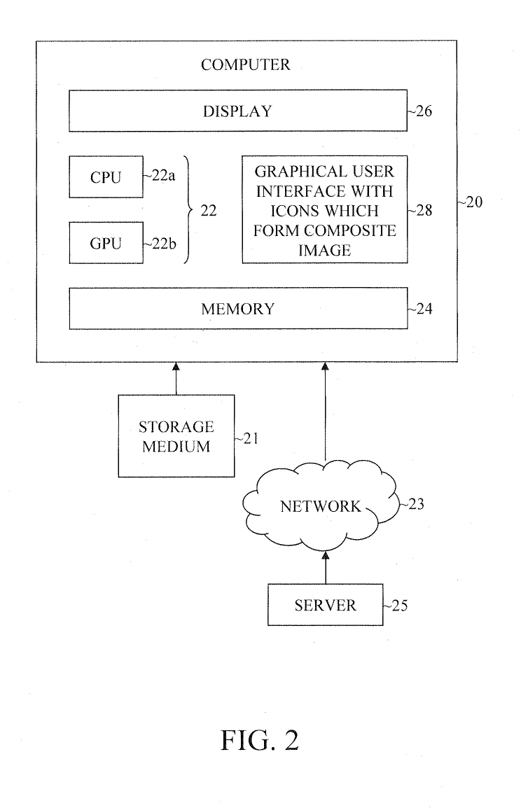

FIG. 2 illustrates an exemplary embodiment of a computer 20. The computer 20 may include one or more processors 22, memory 24, a display 26, and a graphical user interface 28. The computer 20 may include one or more programs (e.g., applications) stored in memory 24 and executed by the one or more processors 22. The computer 20 may download and/or install applications from a storage medium 21 and/or from a server 25 located on a network 23.

Computer 20 may include any suitable device which can be programmed to carry out arithmetic or logical operations. The computer 20 may be included, for example, in a personal computer device such as a notebook or desktop computer, a tablet, a mobile phone, etc.

The one or more processors 22 may include any suitable hardware which carries out instructions of a computer program by performing arithmetical, logical, and input/output operations of computer 20. The one or more processors 22 may include, for example, a printed circuit board and/or integrated circuit. The one or more processors 22 may include, for example, a central processing unit (CPU) 22a and/or graphics processing unit (GPU) 22b.

Memory 24 may include any suitable computer-readable storage medium which stores information in a non-transitory form. Memory 24 may include, for example, magnetic or optical media (e.g., tape, CD-ROM, DVD-ROM, CD-R, CD-RW, DVD-R, DVD-RW, or Blu-Ray disk), random access memory (RAM) read only memory (ROM), volatile or non-volatile memory (e.g., flash memory) and/or other digital data storage media. Memory 24 may be internally accessible (e.g., via an internal bus) or externally accessible (e.g., via a peripheral interface such as the universal serial bus (USB) interface or a communication medium such as a network and/or a wireless link).

Display 26 may include any suitable output device which presents information in visual or tactile form. The display 26 may be internally accessible (e.g., via an internal bus) or externally accessible (e.g., via a peripheral interface such as Video Graphics Array (VGA), Digital Visual Interface (DVI), High Definition Multimedia Interface (HDMI), DisplayPort, component, composite, S-Video, etc.)

Storage medium 21 may include any suitable computer-readable storage medium which stores information in a non-transitory form. Storage medium 21 may include, for example, magnetic or optical media (e.g., tape, CD-ROM, DVD-ROM, CD-R, CD-RW, DVD-R, DVD-RW, or Blu-Ray disk), random access memory (RAM) read only memory (ROM), volatile or non-volatile memory (e.g., flash memory) and/or after digital data storage media. Storage medium 21 may be internally accessible (e.g., via an internal bus) or externally accessible (e.g., via a peripheral interface such as the universal serial bus (USB) interface or a communication medium such as a network and/or a wireless link).

Network 23 may include any suitable collection of computers and other hardware interconnected by communication channels which allow sharing of resources and information. Network 23 may include, for example, a local area network, a wide area network, the Internet, etc.

Server 25 may include any suitable computer hardware or program which runs services to serve the requests of other computer hardware or programs. Server 25 may include, for example, a database server, a file server, a web server, etc.

Graphical user interface 28 may include any suitable user interface which enables users to visually interact with computer 20. Graphical user interface 28, for example, may allow users to interact with computer 20 by manipulating a pointing device such as a mouse, a trackball, a touchpad, etc. or by directly interacting with graphical elements by moving an objected such as a finger or stylus on or near a touchscreen.

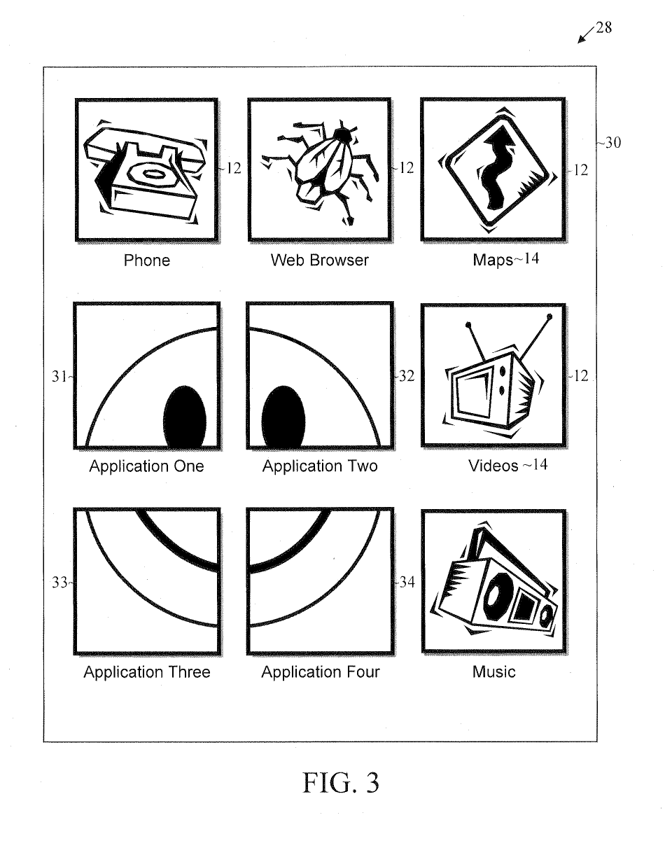

FIG. 3 illustrates an exemplary embodiment of graphical user interface 28. Graphical user interface 28 may include a screen 30 displaying a plurality of icons 12. Each of the plurality of icons 12 may be associated with one or more functions and may include labels 14 identifying those functions as in the prior art.

However, graphical user interface 28 also includes related icons which form a recognizable composite image when juxtaposed. For example, view 30 may include related icons 31-34 which form the composite image of a face when juxtaposed. In this example, the composite image extends across the boundaries of icon 31 that are aligned and proximate to icon 32 and icon 33, the boundaries of icon 32 that are aligned and proximate to icon 31 and icon 34, etc.

In the exemplary embodiment illustrated in FIG. 3, the portion of the face illustrated in icon 31 includes a portion of the outer circle extending to the right-hand boundary of icon 31. The portion of the face illustrated in icon 32 includes a portion of the outer circle extending to the right-hand boundary of icon 32. Accordingly, a portion of the image at the right-hand boundary of icon 31 is identical to a portion of the image at the left-hand boundary of icon 32 (for example, the outer circle of the image of the face at the right-hand boundary of icon 31 and the left-hand boundary of icon 32).

Because the composite image formed by the juxtaposition of icons 31-34 is larger than each of icons 12, the applications associated with icons 31-34 are more visible to the user than the applications associated with icons 12. As described above, increased visibility of icons provides an advantage to the software developer of the applications associated with those icons, namely encouraged greater usage of the developer's applications.

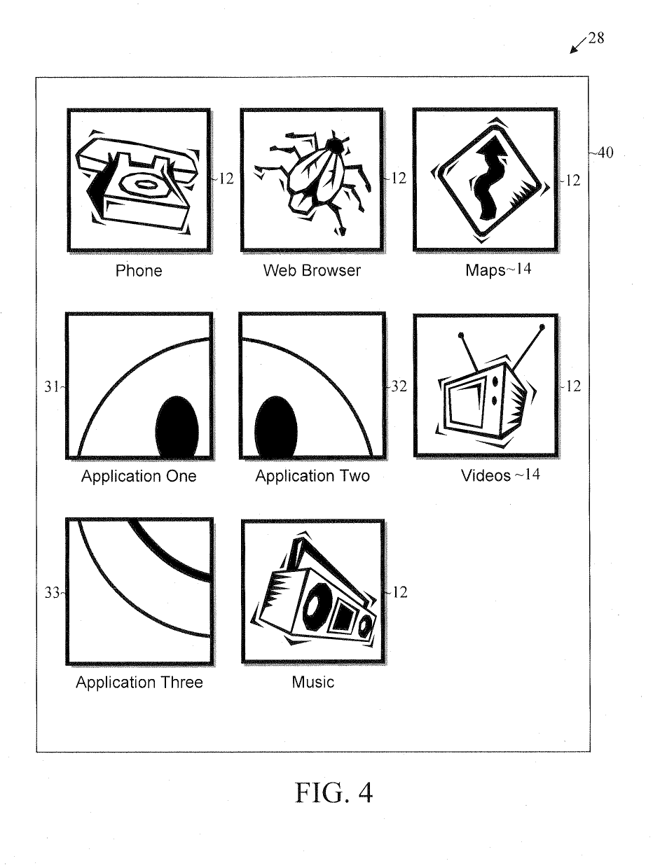

FIG. 4 illustrates another exemplary embodiment of graphical user interface 28. Graphical user interface 28 may include view 40. View 40 includes icons 12 and labels 14 similar to view 30 illustrated in FIG. 3. View 40 includes icons 31-33, however the composite image formed by icons 31-34 of view 30 is incomplete because view 40 does not include icon 34. Because a portion of the composite image is not shown, a graphical user interface 28 which includes view 40 may prompt a user to purchase, download, and/or install the application associated with icon 34 so as to complete the composite image illustrated in view 30 of FIG. 3. In other words, a graphical user interface 28 which includes icons which form a composite image may prompt a user to purchase, download, and/or install all applications associated with the icons which form the composite image.

As described above, prompting a user to install additional applications from a software developer in order to form the composite image provides an advantage of encouraging the user to benefit from all of the functions offered by the software developer's applications. A graphical user interface which prompts a user to purchase any additional applications from a software developer in order to form the composite image also provides an advantage to the software developer, namely increased sales and/or usage of the developer's software.

If the additional application cross-references functionality included in a related application or applications, then a graphical user interface which prompts a user to install any remaining related applications in order to form the composite image encourages reduction of reduced functionality.

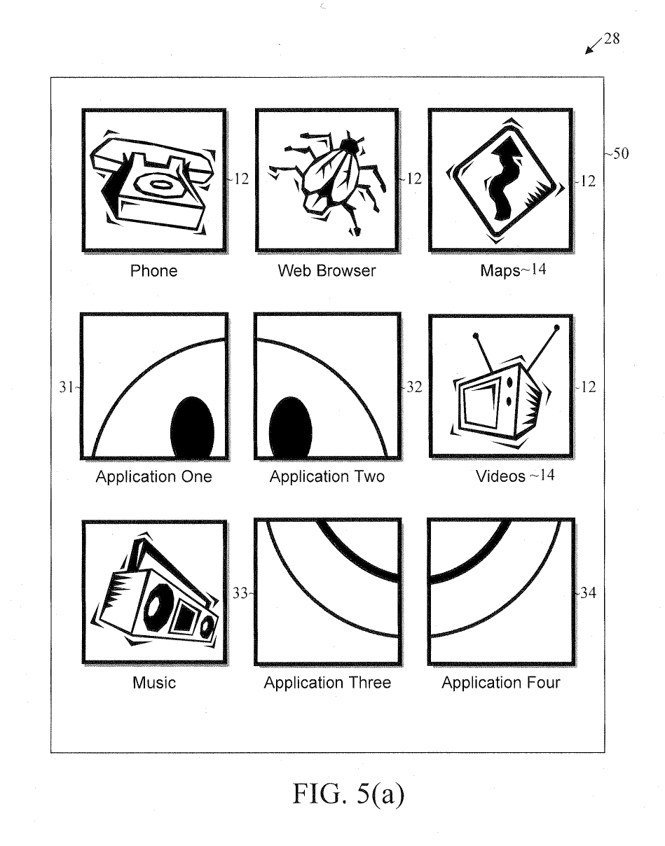

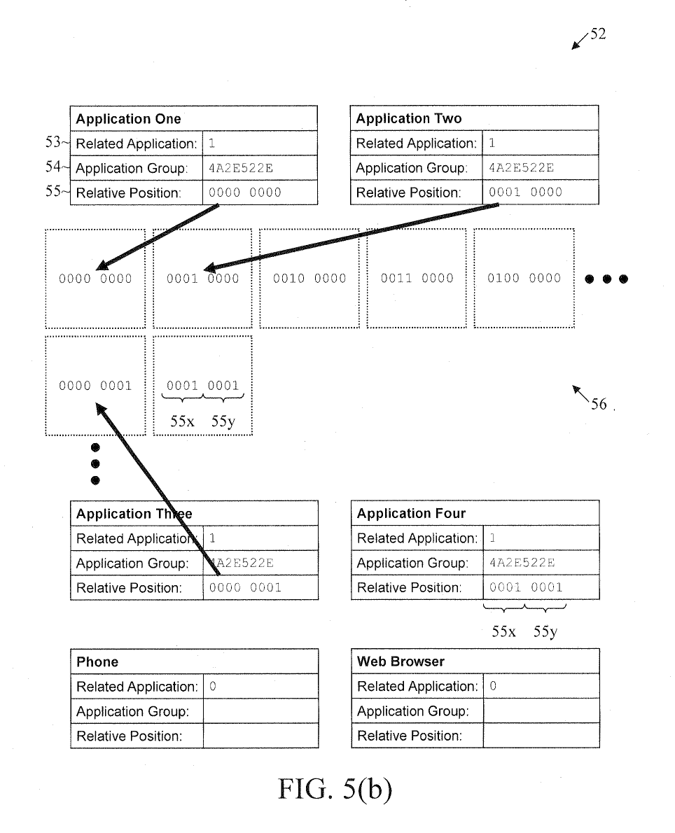

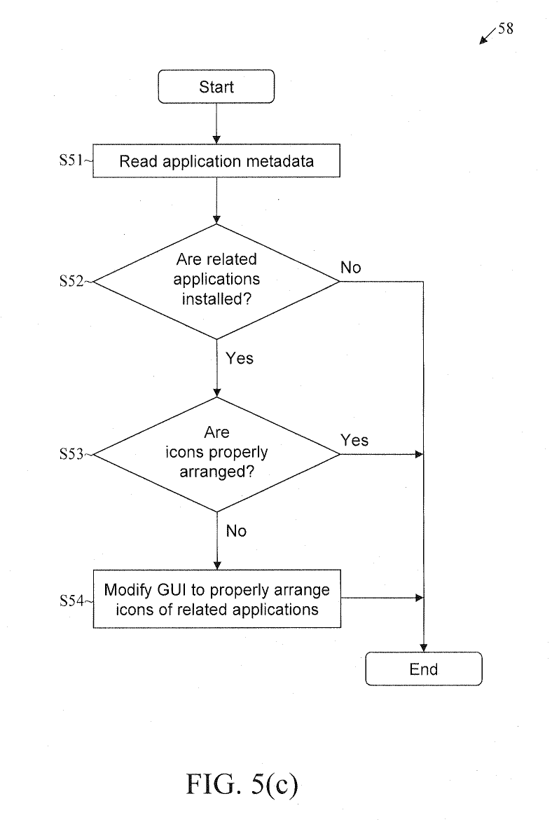

FIG. 5(a) illustrates another exemplary embodiment of graphical user interface 28. Graphical user interface 28 may include view 50. View 50 may include icons 12 and labels 14 similar to view 30 illustrated in FIG. 3. View 50 includes icons 31-34 which form a composite image. Icons 31-34, however, are not aligned in view 50 such that the composite image is properly rendered.

In this instance, the composite image formed by icons 31-34 may prompt a user to rearrange icons 31-34 and icons 12 so as to properly render the composite image. In other words, a user is encouraged to rearrange the icons illustrated in view 50 of FIG. 5(a) so as to form view 30 of FIG. 3.

Alternatively, the device operating system may include instructions to recognize the existence of related application associated with icons 31-34 or recognize that icons 31-34 form a composite image. Therefore, the operating system may automatically rearrange icons 31-34 and icons 12 as shown in view 50 of FIG. 5(a) so as to form view 30 of FIG. 3 (and/or to maintain the relative position of icons 31-34 so as to maintain a proper composite image arrangement.

Applications stored in memory 24 of computer 20 may include metadata indicating whether the applications are related. If an application is related to one or more other applications, the metadata may identify the other related applications and the relative position of the application's icon in order to form the composite image.

FIG. 5(b) illustrates an exemplary embodiment of metadata 52. Metadata 52 may include, for example, related application data 53 which indicates whether an application is related to another application.

Applications may be related if they include icons which form a related image when juxtaposed. Applications may be further related, for example, if they are developed by the same software developer or group of developers or if the applications are branded, marketed, or distributed as a set. Applications may be functionally related if the applications cross-reference functionality (e.g., if one application includes instructions and another application causes those instructions to be executed) or if the applications share data (e.g., if one application stores data in a database or location of memory and another application reads that data).

If the application is related to another application, metadata 52 may include application group data 54 which identifies the group of applications to which the application is related. Each application group may be given one identifier as shown in FIG. 5(b). Alternatively, each application may be given an identifier and application group data 54 may include a list of other applications to which the application is related.

Metadata 52 may also include relative position data 55 indicating the position of the icon relative to the icons of related applications in order to form a composite image. Relative position data 55, for example, may include an x-coordinate 55x and a y-coordinate 55y. The operating system may use x-coordinate 55x and y-coordinate 55y to arrange the icons relative to one another. For example, the operating system may use a coordinate system such as coordinate system 56.

FIG. 5(c) illustrates an exemplary embodiment of control program 58. Control program 58 may be stored in memory 24 of computer 20 which includes graphical user interface 28. Control program 58 may be executed by the one or more processors 22.

The operating system of computer 20 reads application metadata 52 in operation S51. The operating system determines whether related applications are installed in operation S52. For example, the operating system may determine if the metadata 52 includes related application data 53 which indicates whether applications installed in memory 20 are related to one another. If no related applications are installed (Operation S52: No), control program 58 ends.

If related applications are installed, the operating system determines if the icons of related applications are properly arranged in operation S53. For example, the operating system may determine if the metadata 52 includes relative position data 55 and whether graphical user interface 28 displays the icons according to the relative position data 55. If the icons of the related application are properly arranged (Operation S53: Yes), control program 58 ends.

If the icons of related applications are not properly arranged, the operating system modifies graphical user interface 28 to properly arrange the icons of the related applications in operation S54. For example, the operating system may arrange the icons relative to one another based on the relative position data 55 included in metadata 52.

A composite image may be formed by four icons in two columns and rows as illustrated in view 30 of FIG. 3. Graphical user interface 28, however, is not limited in this way.

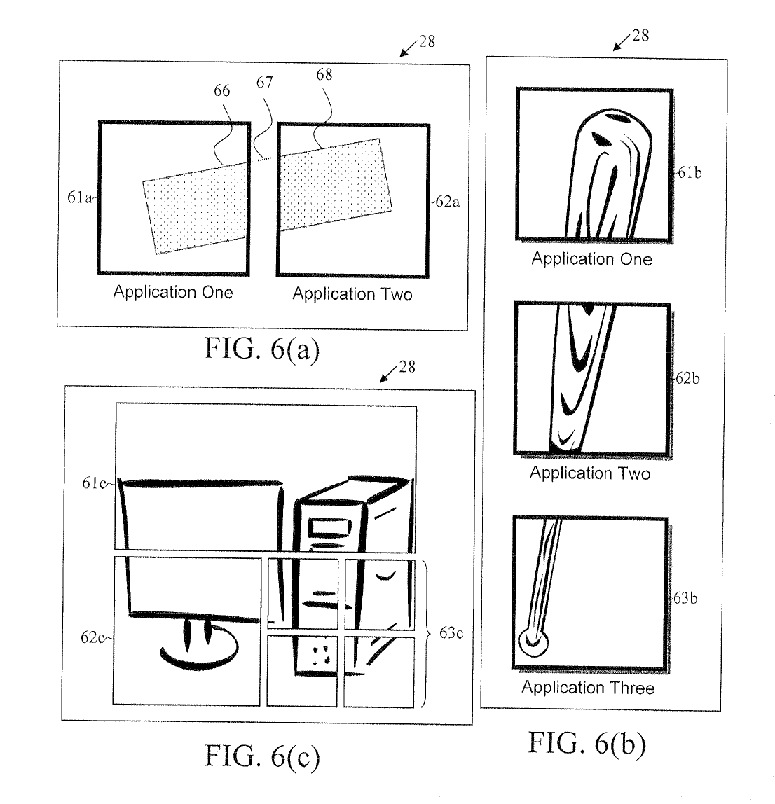

FIGS. 6(a) through 6(c) illustrate other exemplary embodiments of graphical user interface 28. As illustrated in FIG. 6(a), for example, two icons 61a and 62a may form a composite image when juxtaposed horizontally. As illustrated in FIG. 6(b), for example, three icons 61b, 62b, and, 63b may form a composite image when juxtaposed vertically. The icons which form a composite image do not have to be the same size or shape. As illustrated in FIG. 6(c), for example, a large icon 61c, a square icon 62c, and a set of four icons 63c may form a composite image when juxtaposed.

Referring to FIG. 6(a), a first icon 61a may include a line 66 which extends to a boundary of icon 61a. A second icon 62a may include a line 68 which extends to a boundary of icon 61b. In forming the recognizable composite image, first line 66 of icon 61a may be such that, if extended (for example, along the path identified by dotted line 67), line 66 would overlap second line 68.

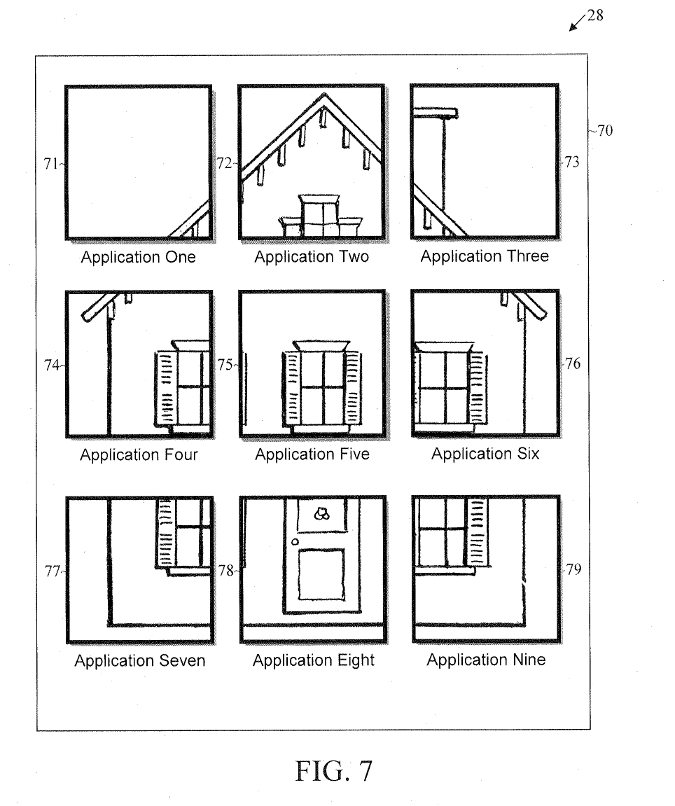

FIGS. 7 through 9 illustrate another exemplary embodiment of graphical user interface 28. As illustrated in FIG. 7, graphical user interface 28 may include view 70. View 70 may include icons 71-79 that form a composite image when juxtaposed in a 9×9 matrix. Icons 71-79 may be associated with nine applications which may be related applications. When new versions of the applications are available, a user may update some or all of the applications. Graphical user interface 28 may include icons which form a different composite image when applications are updated.

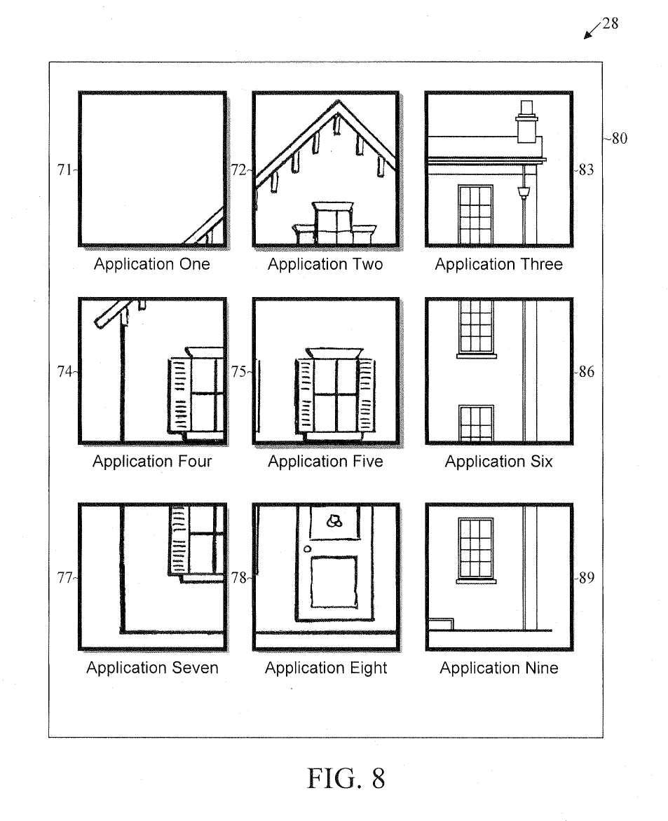

As illustrated in FIG. 8, for example, view 80 includes icons 83, 86, and 89. Whereas icon 73 of view 70 was associated with Application Three, icon 83 is associated with an updated version of Application Three and shows a different image than icon 73. Similarly, icon 86 is associated with an updated version of Application Six and icon 89 is associated with an updated version of Application Nine. The images shown on icons 83, 86, and 89 form a composite image which is different than the composite image formed by icons 71-72, 74-75, and 77-78. This change in icons 83, 86, and 89 may indicate to the user that (a) the applications associated with icons 83, 86, and 89 have been updated; (b) the applications associated with icons 71-72, 74-75, and 77-78 have not been updated; and (c) updated versions of the applications associated with icons 71-72, 74-75, and 77-78 may be available.

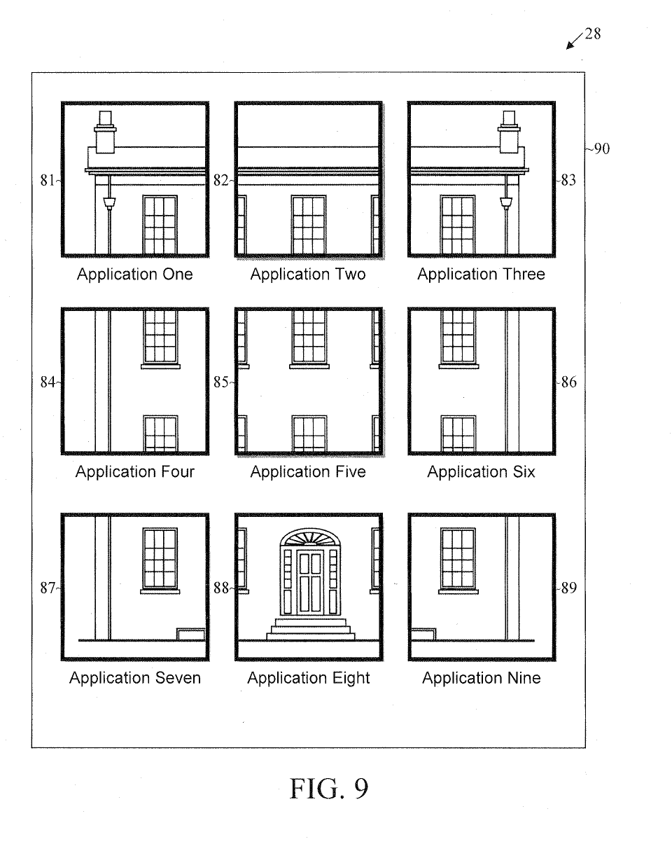

If a user updates the applications associated with icons 71-72, 74-75, and 77-78, the graphical user interface may replace icons 71-72, 74-75, and 77-78 of view 80 with icons 81-82, 84-85, and 87-88 of view 90 as illustrated in FIG. 9. View 90 includes icons 81-89 which form a composite image which is different than the composite image formed by icons 71-79 of view 70 as illustrated in FIG. 7.

As described above, a user must keep multiple applications up to date in order to benefit from all of the functions offered by a software developer's applications. Therefore, icons which form a composite image provide the advantage of indicating to a user that updated versions of a software developer's applications may be available.

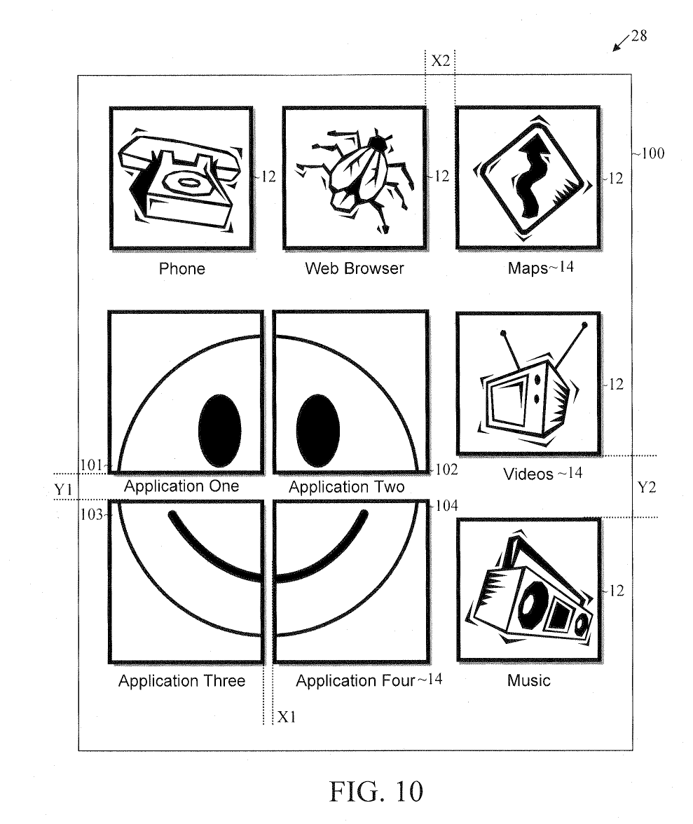

FIG. 10 illustrates another exemplary embodiment of graphical user interface 28. Graphical user interface 28 may include view 100. View 100 may include icons 12 and labels 14 similar to view 30 of FIG. 3. View 100 may also include icons 101-104 which form a composite image when juxtaposed.

The operating system defining graphical user interface 28 may reduce the distance between icons 101-104 which form a composite image relative to the distance between icons 12 which do not form a composite image.

For example, a vertical distance Y1 between icon 101 and 103 may be less than a vertical distance Y2 between icons 12. Also, a horizontal distance X1 between the icon 103 and 104 may be less than a horizontal distance X2 between icons 12.

Icons 101-104 which form a composite image may be larger than icons 12 which do not form a composite image, Distances X1 and Y1 between icons 101-104 may be reduced to zero. In other words, icons 101-104 may abut each other. View 100 may or may not include labels 14 identifying the applications associated with icons 101-104.

While the disclosure has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed is:

1. A device, comprising:
at least one programmed data processor operatively connected to memory and a display; and
a plurality of executable computer programs stored in the memory and configured to be executed by the at least one data processor, the plurality of programs comprising a first application and a second application related to the first application, the at least one data processor also being configured to execute stored program instructions effective to:
display a first icon associated with the first application; and
display a second icon associated with the second application,
wherein the displayed first and second icons form a recognizable composite image when juxtaposed.

2. The device of claim 1, wherein at least one element of the composite image extends across aligned and proximate boundaries of the first icon and the second icon when juxtaposed.

3. The device of claim 1, wherein the at least one data processor is configured to execute stored program instructions effective to:
display a third icon associated with the first application which differs from the first icon in response to a determination that a new version of the first application is installed on the device; and
display a fourth icon associated with the second application which differs from the second icon in response to a determination that a new version of the second application is installed on the device,
wherein the third icon and the fourth icon form a second recognizable composite image when juxtaposed.

4. The device of claim 1, wherein the at least one data processor is configured to execute stored program instructions effective to:
display the second icon juxtaposed to the first icon in response to an automatic determination that the second application is related to the first application.

5. The device of claim 1, wherein the at least one data processor is configured to execute stored program instructions effective to:
display icons closer together which form a recognizable composite image than the display of icons which do not form a recognizable composite image.

6. The device of claim 1, wherein the at least one data processor is configured to execute stored program instructions effective to:
display icons closer together if associated with related applications than the display of icons associated with unrelated applications.

7. A method of generating a graphical user interface on a device having at least one programmed data processor and a display, the method comprising:
displaying a first icon associated with a first application comprising executable computer program instructions; and
displaying a second icon associated with a second application comprising executable computer program instructions, wherein:
the second application is related to the first application, and
the displayed first and second icons form a recognizable composite image when juxtaposed.

8. The method of claim 7, wherein at least one element of the composite image extends across aligned and proximate boundaries of the first icon and the second icon when juxtaposed.

9. The method of claim 7, further comprising:
displaying a third icon associated with the first application which differs from the first icon in response to a determination that a new version of the first application is installed on the device; and
displaying a fourth icon associated with the second application which differs from the second icon in response to a determination that a new version of the second application is installed on the device,
wherein the third icon and the fourth icon form a second recognizable composite image when juxtaposed.

10. The method of claim 7, further comprising:
displaying the second icon juxtaposed to the first icon in response to an automatic determination that the second application is related to the first application.

11. The method of claim 7, further comprising:
displaying icons closer together which form a recognizable composite image than icons which do not form a recognizable composite image.

12. The method of claim 7, further comprising:
displaying icons closer together if associated with related applications than icons associated with unrelated application.

13. A non-transitory computer-readable storage medium storing a plurality of executable computer programs, the plurality of executable computer programs comprising a first application and a second application related to the first application, the plurality of executable computer programs comprising instructions which, when executed by a device having at least one data processor and a display, cause the at least one data processor to:
display a first icon associated with the first application; and
display a second icon associated with the second application,
wherein the first icon and the second icon form a recognizably composite image when the first icon and the second icon are juxtaposed.

14. The computer-readable storage medium of claim 13, further comprising instructions which cause the at least one data processor to:
display a third icon associated with the first application which differs from the first icon in response to a determination that a new version of the first application is installed on the device; and
display a fourth icon associated with the second application which differs from the second icon in response to a determination that a new version of the second application is installed on the device,
wherein the third icon and the fourth icon form a second recognizable composite image when juxtaposed.

15. The computer-readable storage medium of claim 13, further comprising instructions which cause the at least one data processor to:
display the second icon juxtaposed to the first icon in response to an automatic determination that the second application is related to the first application.

16. The computer-readable storage medium of claim 13, further comprising instructions which cause the at least one data processor to:
display icons closer together which form a recognizable composite image than icons which do not form a recognizable composite image.

17. A graphical user interface on a device having at least one programmed data processor and a display, the graphical user interface comprising:
a first icon associated with a first application comprising executable computer program instructions; and
a second icon associated with a second application comprising executable computer program instructions, wherein:
the second application is related to the first application, and
the displayed first and second icons form a recognizable composite image when juxtaposed.

18. The graphical user interface of claim 17, further comprising:
a third icon associated with the first application which differs from the first icon in response to a determination that a new version of the first application is installed on the computer; and
a fourth icon associated with the second application which differs from the second icon in response to a determination that a new version of the second application is installed on the computer,
wherein the third icon and the fourth icon form a second recognizable composite image when juxtaposed.

19. The graphical user interface of claim 17, wherein the second icon is juxtaposed to the first icon in response to an automatic determination that the second application is related to the first application.

20. The graphical user interface of claim 17, wherein icons which form a composite image are arranged closer together than icons which do not form a composite image.
